(19) United States
(12) Patent Application Publication
(10) Pub. No.: US 2026/0139650 A1
(43) Pub. Date: May 21, 2026

(54) FUEL PUMP FOR A DIRECT INJECTION SYSTEM

(71) Applicant: Marelli Europe S.p.A., Corbetta (MI) (IT)

(72) Inventors: Armando SPIZZIRRI, CORBETTA – MI (IT); Riccardo MARIANELLO, CORBETTA – MI (IT); Michele PETRONE, CORBETTA – MI (IT)

(21) Appl. No.: 19/394,372

(22) Filed: Nov. 19, 2025

(30) Foreign Application Priority Data
Nov. 19, 2024 (IT) 102024000026010

(51) Int. Cl. F02M 59/46; F02M 59/02

(52) U.S. Cl. CPC F02M 59/46; F02M 59/025

(57) ABSTRACT

A fuel pump for a direct injection system having: a main body; a pumping chamber defined in the main body; a valve, which is configured to adjust the flow of fuel through the pumping chamber and has a valve disc having a series of through holes and a flexible sheet provided with a series of shutting portions, each shaped so as to rest against an outer wall of the valve disc, thus closing the passage through a respective through hole; and a plurality of grooves, each arranged, at least when the valve is closed, in the area of the outer wall of the valve disc and around a respective through hole so as to reduce a contact surface between the outer wall of the valve disc and an inner wall of the corresponding shutting portion.

### CROSS-REFERENCE TO RELATED APPLICATION

This application claims priority pursuant to 35 U.S.C. 119(a) to Italian Patent Office Application No. 102024000026010, filed November 19, 2024, which application is incorporated herein by reference in its entirety

### FIELD OF THE INVENTION

The present invention relates to a fuel pump for a direct injection system.

### BACKGROUND

A direct injection system comprises a plurality of injectors, a common rail which feeds the fuel under pressure to the injectors, a high-pressure fuel pump, which feeds the fuel to the common rail by means of a high-pressure feeding duct and is provided with a flow rate adjustment device, and a control unit which controls the flow rate adjustment device for maintaining the pressure of the fuel inside the common rail equal to an intended value generally variable over time depending on the operation conditions of the engine.

The high-pressure pump described in International Patent Application No. WO2021234661A1 comprises a main body which defines a pumping chamber with a cylindrical shape, inside which a piston slides with reciprocating motion; an intake duct adjusted by an intake valve for feeding the fuel at a low pressure inside the pumping chamber, and a delivery duct adjusted by a delivery valve for feeding the fuel at a high pressure outside of the pumping chamber and towards the common rail through the feeding duct are provided.

Noise is taking on an increasingly important role in today’s automotive world and, therefore, an increasingly greater attention is being paid to reducing the noise generated by all vehicle components and, therefore, by the high-pressure fuel pump, as well. Due to their constructive simplicity, flat shutters are normally used in the delivery valve and/or the intake valve; however, flat shutters generate a relatively high noise during the opening step, which can be perceived even outside the engine compartment.

### SUMMARY

The object of the present invention is to provide a fuel pump for a direct injection system, which fuel pump is noiseless and, at the same time, is easy and cost-effective to manufacture, as well.

According to the present invention, a fuel pump for a direct injection system is provided according to what is claimed in the appended claims.

The claims describe preferred embodiments of the present invention, forming an integral part of the present description.

### BRIEF DESCRIPTION OF THE DRAWINGS

The present invention will now be described with reference to the accompanying drawings, which illustrate some non-limiting example embodiments thereof, wherein:

FIG. 1 is a schematical view, with parts removed for clarity, of a direct fuel injection system of the common rail type for an internal combustion engine;

FIG. 2 is a cross-sectional view, with parts removed for clarity, of a high-pressure fuel pump of the injection system of FIG. 1;

FIG. 3 is a longitudinal sectional view of part of a valve assembly integrating a delivery valve and a maximum pressure valve of the high-pressure fuel pump of FIG. 2;

FIG. 4 is a perspective view of a valve disc of the valve assembly of FIG. 3;

FIG. 5 is a cross-sectional view of the valve disc of FIG. 4;

FIG. 6 is a view on an enlarged scale of a detail of FIG. 5; and,

FIG. 7 is a variation of the detail illustrated in FIG. 6.

### DETAILED DESCRIPTION OF THE INVENTION

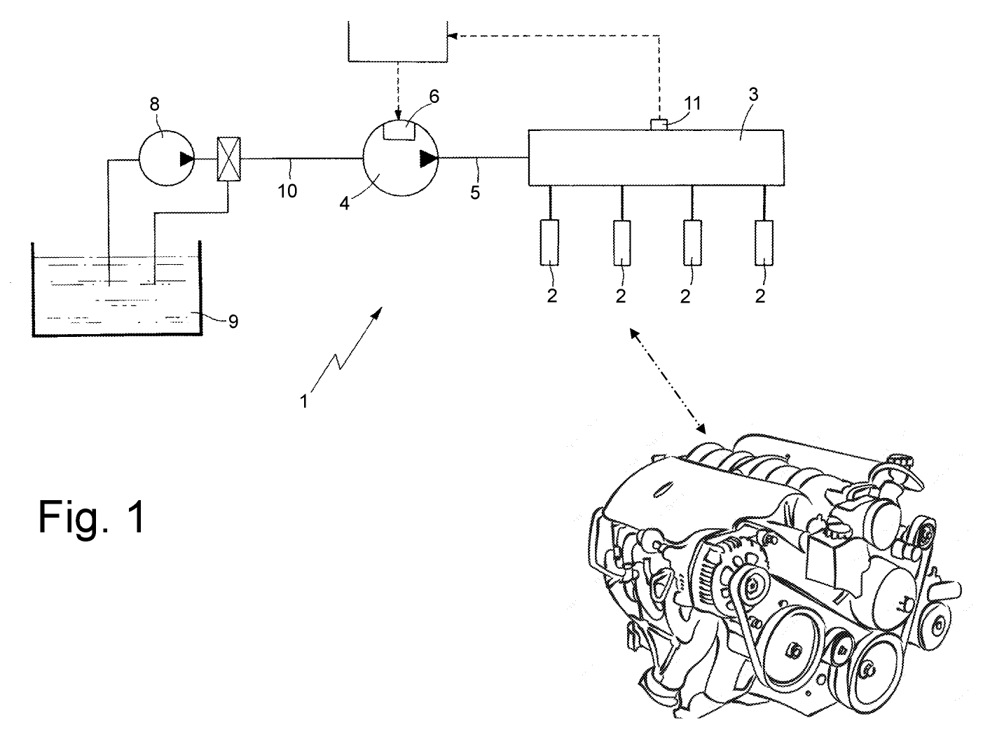

In FIG. 1, reference numeral 1 indicates a direct fuel injection system of the common rail type for an internal combustion engine. The direct injection system 1 comprises a plurality of injectors 2, a common rail 3 which feeds the fuel under pressure to the injectors 2, a high-pressure pump 4, which feeds the fuel to the common rail 3 by means of a feeding duct and is provided with a flow rate adjustment device 6, a control unit 7 which maintains the pressure of the fuel inside the common rail 3 equal to an intended value generally variable over time depending on the operation conditions of the internal combustion engine, and a low-pressure pump 8 which feeds the fuel from a tank 9 to the high-pressure pump 4 by means of a feeding duct 10.

The control unit 7 is coupled to the flow rate adjustment device 6 for controlling the flow rate of the high-pressure pump 4 so as to feed on an instant-by-instant basis to the common rail 3 the amount of fuel necessary to achieve the intended pressure value inside the common rail 3; in particular, the control unit 7 adjusts the flow rate of the high-pressure pump 4 by means of a feedback control which uses the value of the fuel pressure (detected in real time by the pressure sensor 11) inside the common rail 3 as a feedback variable.

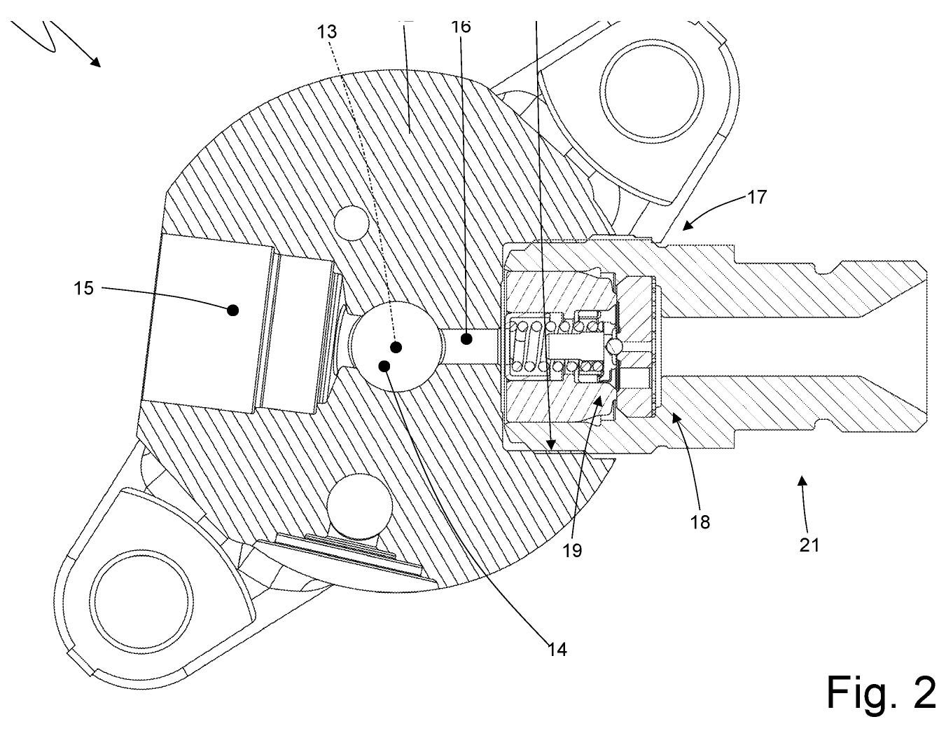

According to what is illustrated in FIG. 2, the high-pressure pump 4 comprises a main body 12 which has a longitudinal axis 13 and defines therein a pumping chamber 14 with a cylindrical shape. Inside the pumping chamber 4, a piston (not illustrated) is mounted in a sliding manner which, by moving with reciprocating motion along the longitudinal axis 13, causes a cyclical variation in the volume of the pumping chamber 14.

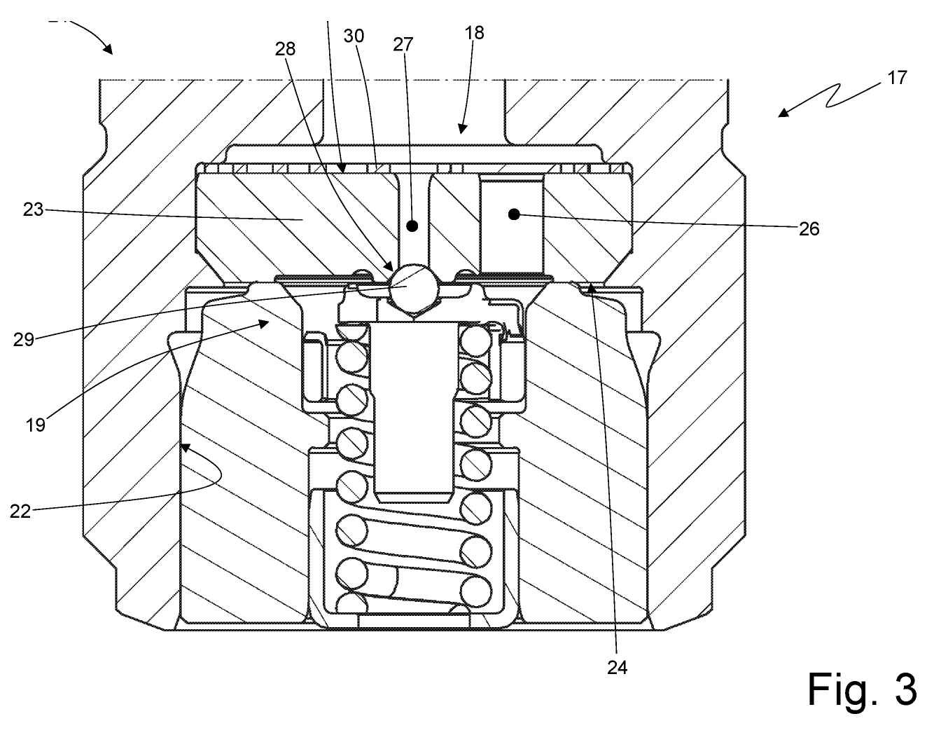

From a side wall of the pumping chamber 14, an intake channel 15 directly originates which is connected to the low-pressure pump 4 and is adjusted by a one-way intake valve (not illustrated) arranged in the area of the pumping chamber 14. From a side wall of the pumping chamber 14 and from the opposite side with respect to the intake channel 15, a delivery channel 16 directly originates which is connected to the common rail 3 and is engaged by a valve assembly 17 (illustrated in detail in FIG. 3).

The valve assembly 17 is arranged in the area (in the proximity) of the pumping chamber 14 and integrates both a one-way delivery valve 18 (also referred to as “OCV – Outlet Closing Valve”), which allows fuel to only flow out of the pumping chamber 14 through the delivery channel 16, and a one-way maximum pressure valve 19 (also referred to as “PRV – Pressure Relief Valve”), which allows fuel to only flow into the pumping chamber 14 through the delivery channel 16. In other words, the maximum pressure valve 19 is arranged together with the delivery valve 18 and coaxially to the delivery valve 18, forming a single integrated assembly (the valve assembly 17) with the delivery valve 18: the one-way delivery valve 18 allows fuel to only flow out of the pumping chamber 14 through the delivery channel 16, whereas the one-way maximum pressure valve 19 opens when the pressure of the fuel downstream of the maximum pressure valve 19 exceeds a threshold value to allow fuel to only flow into the pumping chamber 14 through the delivery channel 16.

During the normal operation of the high-pressure pump 14, the delivery valve 18 opens and closes at every pumping cycle: the delivery valve 18 is operated under pressure and, in particular, the delivery valve 18 is opened when the pressure of the fuel in the pumping chamber 14 (i.e., upstream of the delivery valve 18) is sufficiently higher than the pressure of the fuel downstream of the delivery valve 18 (i.e., when the piston is in the pumping step and is reducing the volume of the pumping chamber 14), and is closed when the pressure of the fuel in the pumping chamber 14 (i.e., upstream of the delivery valve 18) is lower than the pressure of the fuel downstream of the delivery valve 18 (i.e., when the piston is in the intake step and is increasing the volume of the pumping chamber 14).

The function of the maximum pressure valve 19 is to allow the fuel to be released in the event where the pressure of the fuel in the common rail 3 (i.e., downstream of the valve assembly 17) exceeds a maximum value established during the design phase (e.g., in the event of errors in the control carried out by a control unit or in the event of a fault in one injector connected to the common rail); in other words, the maximum pressure valve 19 is calibrated to open automatically when the pressure difference at the ends thereof is greater than a threshold value established during the design phase and, therefore, prevent the pressure of the fuel in the common rail 3 (i.e., downstream of the valve assembly 17) from exceeding the maximum value established during the design phase.

The fuel pump 1 has a containment cavity 20 with a cylindrical shape and internally threaded which is coaxial to the delivery channel 16, directly communicates with the delivery channel 16 (i.e., it is immediately adjacent to the delivery channel 16 and constitutes the natural continuation of the delivery channel 16), and is arranged downstream of the delivery channel 16 with respect to the pumping chamber 14; the valve assembly 17 further comprises a connector 21 with a cylindrical shape and externally threaded which is screwed into the containment cavity 20 and is adapted to connect the delivery channel 16 with a subsequent fuel feeding duct; typically, the fuel feeding duct is screwed around a beak of the connector 21.

According to what is illustrated in FIG. 3, the connector 21 has a housing 22 having an end proximal to the pumping chamber 14 which is open, is coaxial to the delivery channel 16, and faces the delivery channel 16 to receive the axially flowing fuel directly from the delivery channel 16 and thus let the fuel axially enter into the housing 22.

The valve assembly 17 comprises a valve disc 23 which is arranged in the housing 22 of the connector 21 (i.e., which engages the housing 22 of the connector 21) and has an inner wall 24 (with a circular shape) facing the pumping chamber 14, and an outer wall 25 (with a circular shape) which is parallel to and opposite the inner wall 24, faces the opposite side of the pumping chamber 14, and rests against an annular shoulder of the housing 22.

The valve disc 23 has a series of delivery through holes 26 (with a circular shape, i.e. having a circle-shaped cross-section) and, in particular, three delivery through holes 26 are provided, symmetrically arranged around a longitudinal axis of the valve disc 23; the fuel can flow through the delivery holes 26 and these are part of the delivery valve 18, i.e. they are used only by the delivery valve 18. Furthermore, the valve disc 23 has a single release through hole 27 (centrally arranged) through which the fuel can flow and which is part of the maximum pressure valve 19, i.e., it is used only by the maximum pressure valve 19; the release hole 27 is provided with a valve seat 28 which is obtained in the area of the outer wall 25 of the valve disc 23. The maximum pressure valve 19 comprises a shutter 29 with a spherical shape which is adapted to engage the valve seat 28 of the release hole 27 and is movable to detach from the valve seat 28 when the difference between the pressure downstream of the valve disc 23 and the pressure of the fuel upstream of the valve disc 23 (i.e. in the pumping chamber 14) exceeds a predetermined intervention threshold.

In the embodiment illustrated in the accompanying Figures, the valve disc 23 has a single release hole 27 centrally arranged, and a plurality of delivery holes 26 (e.g., three delivery holes 26) arranged around the release hole 27 along an imaginary circumference centered on the release hole 27 (i.e., symmetrically arranged around a longitudinal axis of the valve disc 23). According to other, not illustrated embodiments, the number and/or arrangement of the delivery holes 26 can be different.

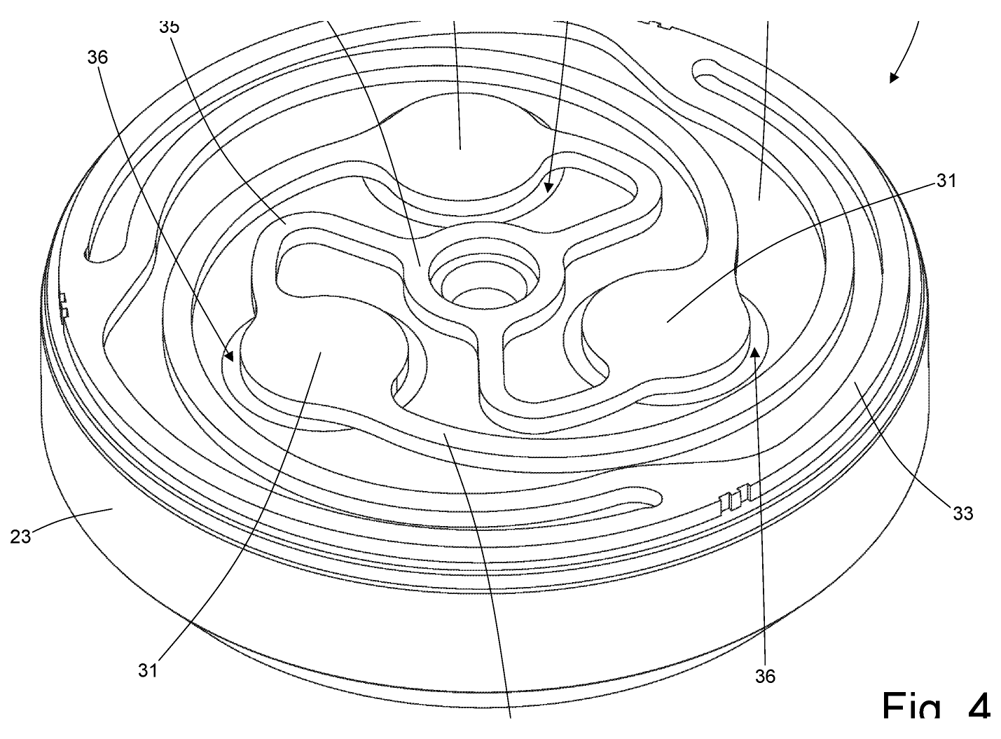

The delivery valve 18 further comprises a flexible sheet 30 with a circular shape (better illustrated in FIG. 4) which rests against the inner wall 24 of the valve disc 23, closing the passage through the delivery holes 26; in particular, the flexible sheet 30 is firmly connected (welded) at some points (relatively far from the delivery holes 26) to the outer wall 25 of the valve disc 23 so as to be attached to the valve disc 23 next to the delivery holes 26. The flexible sheet 30, which constitutes a shutter of the delivery valve 18 and integrates the elastic element thereof as well, engages the valve seats of the delivery holes 26 and is movable to detach from the valve seats when the pressure of the fuel downstream of the valve disc 23 is lower than the pressure of the fuel upstream of the valve disc 23.

The delivery valve 18 is operated under pressure and the delivery valve 18 is closed when the pressure of the fuel upstream of the valve disc 23 (i.e., in the pumping chamber 14) is lower than the pressure of the fuel downstream of the valve disc 23, and is opened when the pressure of the fuel upstream of the valve disc 23 (i.e., in the pumping chamber 14) is (sufficiently) higher than the pressure of the fuel downstream of the valve seat 23. In particular, when the fuel flows from the pumping chamber 14 into the delivery channel 16, the flexible sheet 30 deforms while moving away from the valve disc 23 under the thrust of the fuel, allowing the fuel to pass through the delivery through holes 26; instead, when the fuel attempts to flow from the delivery channel 16 towards the pumping chamber 14, the flexible sheet 30 gets pressed against the valve disc 23, sealing the delivery holes 26 and, therefore, preventing the fuel from passing through the delivery holes 26.

According to what is illustrated in FIG. 4, the flexible sheet 30 comprises three shutting portions 31 (i.e., three “petals”) with a circular shape, each having a circular shape, being arranged in the area of a corresponding delivery hole 26 and being configured to prevent the fuel from passing through the corresponding delivery hole 26 when the delivery valve 18 is closed.

Furthermore, the flexible sheet 30 comprises a central mounting portion 32 which is arranged at the center and is centrally perforated (i.e. has a through hole at the center) so as not to obstruct the release hole 27; in other words, the central mounting portion 32 has an annular shape to surround (without obstructing) the release hole 27. The flexible sheet 30 comprises a peripheral mounting portion 33 with an annular shape, which is arranged laterally (i.e., along the outer edge of the valve disc 23). The peripheral mounting portion 33 is firmly connected (in particular, welded) at some points to the valve disc 23; the central mounting portion 32 can be firmly connected (in particular, welded) to the valve disc 23 or, alternatively, it can also be completely disconnected from the valve disc 23.

The flexible sheet 30 comprises three outer connecting portions 34, each having a semi-circular shape and connecting the peripheral mounting portion 33 to a corresponding shutting portion 31; i.e., each outer connecting portion 34 originates from the peripheral mounting portion 33 and ends in a corresponding shutting portion 31. The flexible sheet 30 comprises three inner connecting portions 35, each having a “U” shape and connecting the central mounting portion 32 to a corresponding shutting portion 31; i.e. each inner connecting portion 35 originates from the central mounting portion 32 and ends in a corresponding shutting portion 31 on the opposite side of the corresponding outer connecting portion 34. In other words, the two connecting portions 34 and 35 of a same shutting portion 31 are arranged on opposite sides of the shutting portion 31.

According to a preferred embodiment, the flexible sheet 30 is pre-deformed so that, in the absence of external stresses (i.e., in the absence of hydraulic forces generated by the fuel under pressure), it gets pressed against the outer wall 25 of the valve disc 23 with a pre-load force other than zero; generally, such a pre-load force is greater than 1 newton and comprised between 1 and 3 newtons. In particular, the connecting portions 34 and 35 of the flexible sheet 30 are plastically pre-deformed so that, in the absence of external stresses and constraints, the shutting portions 31 are parallel and spaced apart from the mounting portions 32 and 33; when the flexible sheet 30 is attached to the outer wall 25 of the valve disc 23, it is necessary to apply on the flexible sheet 30 the pre-load force in order to bring the mounting portions 32 and 33 coplanar to the shutting portions 31, causing an elastic deformation of the connecting portions 34 and 35.

The conformation described above of the sheet 30 allows the sheet 30 to have a high torsional strength and, therefore, allows the shutting portions 31 of the sheet 30 to always move parallel to themselves (therefore, parallel to the outer wall 25 of the valve disc 23) both in the opening and in the closing steps, ensuring excellent dynamics of the delivery valve 18 (i.e., the delivery valve 18 opens and closes quickly and without difficulty).

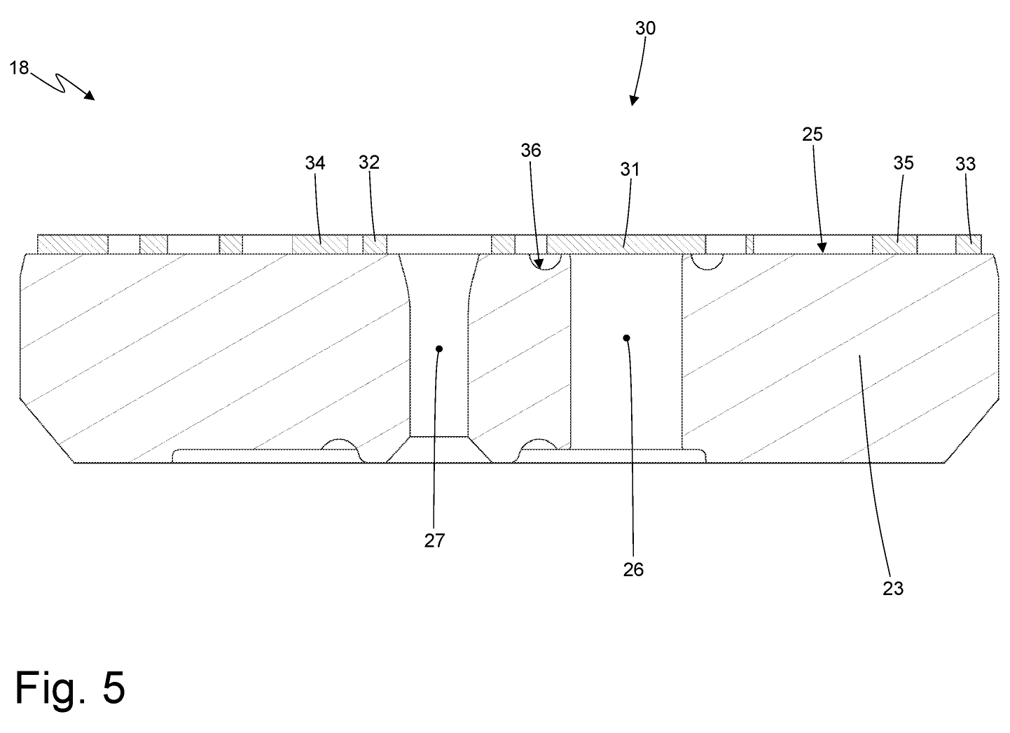

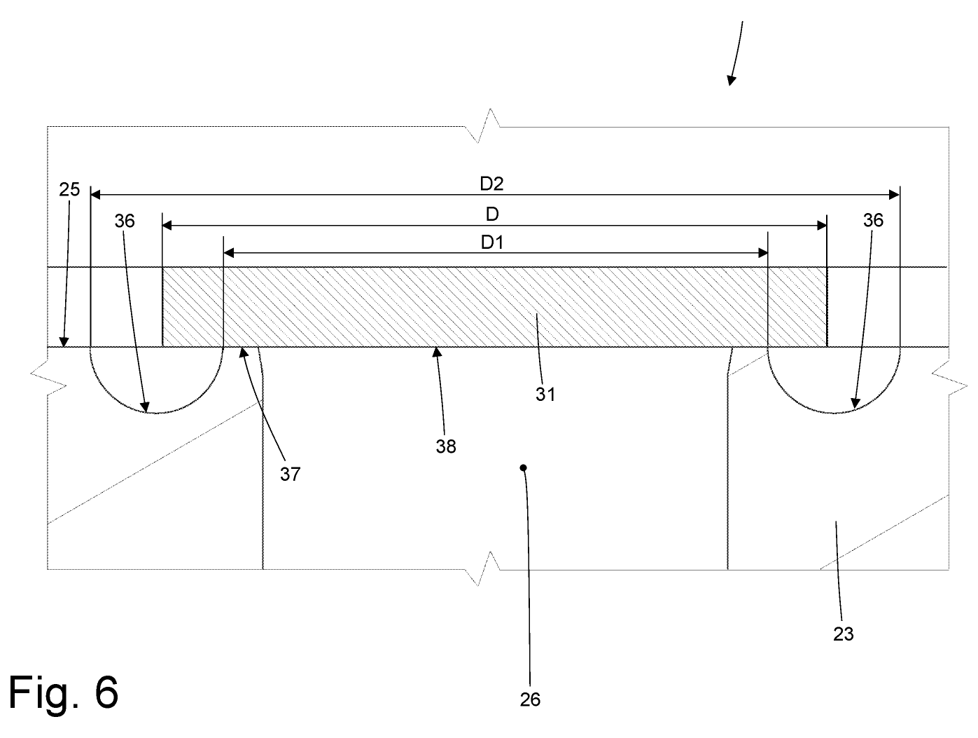

According to what is illustrated in FIG. 5 (and better illustrated in FIG. 6), around each delivery hole 26 the outer wall 25 has a corresponding circular groove 36, which is recessed into the outer wall 25, is arranged at a distance other than zero from the delivery hole 26, and surrounds the delivery hole 26; i.e., between each delivery hole 26 and the corresponding groove 36, there is a valve seat 37 with a circular shape, which is flat (i.e. coplanar to the remainder of the outer wall 25 of the valve disc 23) and separates the delivery hole 26 from the groove 36. The inner diameter D1 of each groove 36 is smaller than an outer diameter D of the corresponding shutting portion 31, whereas the outer diameter D2 of each groove 36 is larger than the outer diameter D of the corresponding shutting portion 31; in this manner, the outer edge of each shutting portion 31 is located approximately in the middle of the respective groove 36 when the shutting portion 31 rests against the outer wall 25 of the valve disc 23 (i.e., when the shutting portion 31 rests against the valve seat 37 of the outer wall 25 of the valve disc 23).

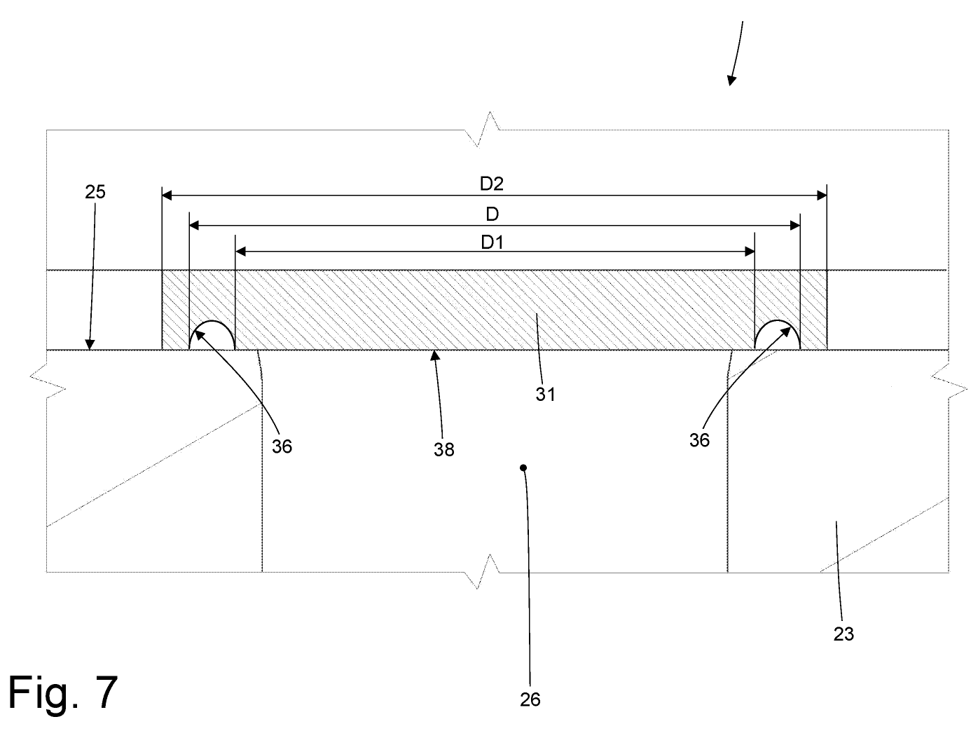

In the embodiment illustrated in FIGS. 3, 4, and 5, the grooves 36 are obtained in the outer wall 25 of the valve disc 23. In the alternative embodiment illustrated in FIG. 7, instead of being obtained in the outer wall 25 of the valve disc 23, the grooves 36 are obtained in the inner wall 38 (i.e., the wall facing the outer wall 25) of the shutting portions 31 that, in use, rests against the outer wall 25 of the valve disc 23. In the embodiment illustrated in FIG. 7, the inner diameter D1 and the outer diameter D2 of each groove 36 are smaller than the outer diameter D of the corresponding shutting portion 31; in this manner, the outer edge of each shutting portion 31 is located further outside the respective groove 36.

To summarize, a plurality of grooves 36 is provided, each being arranged, at least when the delivery valve 18 is closed, in the area of the outer wall 25 of the valve disc 23 and around a respective delivery hole 26 so as to reduce a contact surface between the outer wall 25 of the valve disc 23 and the inner wall 38 of the corresponding shutting portion 31.

The conformation of the delivery valve 18 having the sheet 30 and the grooves 36 could be used in the intake valve, as well.

The embodiments described herein can be combined with one another.

The fuel pump 4 described above has several advantages.

Firstly, the fuel pump 4 described above is capable of significantly reducing the noise that is generated, in use, in the delivery valve 18 due to the contact between the shutting portions 31 of the sheet 30 and the outer wall 25 of the valve disc 23; indeed, the presence of the grooves 36 allows the overall contact area between each shutting portion 31 and the outer wall 25 of the valve disc 23 (i.e., the valve seat 37 of the outer wall 25 of the valve disc 23) to be significantly reduced and, therefore, allows all phenomena generating noise due to the contact between the shutting portions 31 of the sheet 30 and the outer wall 25 of the valve disc 23 to be significantly reduced.

Furthermore, the presence of the grooves 36 affects in no way the quality of the hydraulic sealing of the shutting portions 31 which remains excellent (i.e., more than sufficient to achieve the objectives required in the design phase).

The presence of the grooves 36 allows keeping the shutting portions 31 wide (i.e., with a large outer diameter D) to compensate for errors in the positioning of the shutting portions 31 with respect to the feeding holes 28 (i.e., mounting errors causing eccentricity between the shutting portions 31 and the feeding holes 28); in this manner, it is possible to couple the sheet 30 (and, in particular, the shutting portions 31 of the sheet 30) to the outer wall 25 of the valve disc 23 with a precision that is not too high, thereby avoiding having to resort to extremely precise mountings which involve much higher production costs.

Finally, the fuel pump 4 described above does not feature a significant cost increase compared to a similar standard fuel pump without grooves 36, since making the grooves 36 in the outer wall 25 of the valve disc 23 before coupling the sheet 30 requires a simple and quick mechanical processing.

### LIST OF THE REFERENCE NUMERALS

1 Injection system

2 Injectors

3 Common rail

4 High-pressure pump

5 Feeding duct

6 Adjusting device

7 Control unit

8 Low-pressure pump

9 Tank

10 Feeding duct

11 Pressure sensor

12 Main body

13 Longitudinal axis

14 Pumping chamber

15 Intake channel

16 Delivery channel

17 Valve assembly

18 Delivery valve

19 Maximum pressure valve

20 End portion

21 Connector

22 Housing

23 Valve disc

24 Inner wall

25 Outer wall

26 Delivery holes

27 Release hole

28 Valve seat

29 Shutter

30 Sheet

31 Shutting portions

32 Central mounting portion

33 Peripheral mounting portion

34 Outer connecting portions

35 Inner connecting portions

36 Groove

37 Valve seat

38 Inner wall

D Outer diameter

D1 Inner diameter

D2 Outer diameter

What is claimed is:

1. A fuel pump for a direct injection system, comprising:
a main body;
a pumping chamber defined in the main body;
a valve, which is configured to adjust the flow of fuel through the pumping chamber and comprises a valve disc having a series of through holes and a flexible sheet provided with a series of shutting portions, each shaped so as to rest against an outer wall of the valve disc, thus closing the passage through a respective through hole; and,
a plurality of grooves, each arranged, at least when the valve is closed, in the area of the outer wall of the valve disc and around a respective through hole so as to reduce a contact surface between the outer wall of the valve disc and an inner wall of the corresponding shutting portion.

2. The fuel pump according to claim 1, wherein each groove is arranged at a distance other than zero from the through hole and surrounds the through hole.

3. The fuel pump according to claim 1, wherein the grooves are obtained in the outer wall of the valve disc.

4. The fuel pump according to claim 3, wherein, around each through hole, the outer wall of the valve disc has a corresponding circular groove, which is recessed into the outer wall and surrounds the through hole.

5. The fuel pump according to claim 4, wherein between each through hole and the corresponding groove there is a valve seat with a circular shape, which is flat and separates the through hole from the groove.

6. The fuel pump according to claim 4, wherein an inner diameter of each groove is smaller than an outer diameter of the corresponding shutting portion and an outer diameter of each groove is larger than the outer diameter of the corresponding shutting portion.

7. The fuel pump according to claim 1, wherein the grooves are obtained in the inner wall of the shutting portions.

8. The fuel pump according to claim 7, wherein an inner diameter and an outer diameter of each groove are smaller than an outer diameter of the corresponding shutting portion.

9. The fuel pump according to claim 1, wherein the flexible sheet comprises:
a central mounting portion, which is arranged at the center of the valve disc;
a peripheral mounting portion with an annular shape, which is arranged along an outer edge of the valve disc;
a plurality of outer connecting portions, each connecting the peripheral mounting portion to a corresponding shutting portion; and,
a plurality of inner connecting portions, each connecting the central mounting portion to a corresponding shutting portion.

10. The fuel pump according to claim 1, wherein the flexible sheet is pre-deformed so that, in the absence of external stresses, it gets pressed against the outer wall of the valve disc with a pre-load force other than zero.

11. The fuel pump according to claim 1, wherein a delivery channel originates from a side wall of the pumping chamber, along which channel the valve is arranged, serving as a one-way delivery valve which allows fuel to only flow out of the pumping chamber.

12. The fuel pump according to claim 11, wherein the valve disc supports, on one side, the delivery valve and supports, on the opposite side, a one-way maximum pressure valve, which allows fuel to only flow into the pumping chamber.

13. The fuel pump according to claim 2, wherein the grooves are obtained in the outer wall of the valve disc.

14. The fuel pump according to claim 5, wherein an inner diameter of each groove is smaller than an outer diameter of the corresponding shutting portion and an outer diameter of each groove is larger than the outer diameter of the corresponding shutting portion.

15. The fuel pump according to claim 2, wherein the grooves are obtained in the inner wall of the shutting portions.

16. The fuel pump according to claim 2, wherein the flexible sheet comprises:
a central mounting portion, which is arranged at the center of the valve disc;
a peripheral mounting portion with an annular shape, which is arranged along an outer edge of the valve disc;
a plurality of outer connecting portions, each connecting the peripheral mounting portion to a corresponding shutting portion; and,
a plurality of inner connecting portions, each connecting the central mounting portion to a corresponding shutting portion.

17. The fuel pump according to claim 3, wherein the flexible sheet comprises:
a central mounting portion, which is arranged at the center of the valve disc;
a peripheral mounting portion with an annular shape, which is arranged along an outer edge of the valve disc;
a plurality of outer connecting portions, each connecting the peripheral mounting portion to a corresponding shutting portion; and,
a plurality of inner connecting portions, each connecting the central mounting portion to a corresponding shutting portion.

18. The fuel pump according to claim 4, wherein the flexible sheet comprises:
a central mounting portion, which is arranged at the center of the valve disc;
a peripheral mounting portion with an annular shape, which is arranged along an outer edge of the valve disc;
a plurality of outer connecting portions, each connecting the peripheral mounting portion to a corresponding shutting portion; and,
a plurality of inner connecting portions, each connecting the central mounting portion to a corresponding shutting portion.

19. The fuel pump according to claim 5, wherein the flexible sheet comprises:
a central mounting portion, which is arranged at the center of the valve disc;
a peripheral mounting portion with an annular shape, which is arranged along an outer edge of the valve disc;
a plurality of outer connecting portions, each connecting the peripheral mounting portion to a corresponding shutting portion; and,
a plurality of inner connecting portions, each connecting the central mounting portion to a corresponding shutting portion.

20. The fuel pump according to claim 6, wherein the flexible sheet comprises:
a central mounting portion, which is arranged at the center of the valve disc;
a peripheral mounting portion with an annular shape, which is arranged along an outer edge of the valve disc;
a plurality of outer connecting portions, each connecting the peripheral mounting portion to a corresponding shutting portion; and,
a plurality of inner connecting portions, each connecting the central mounting portion to a corresponding shutting portion.
